(19) United States
(12) Patent Application Publication
(10) Pub. No.: US 2016/0125286 A1
(43) Pub. Date: May 5, 2016

(54) SEALING TAG WITH CONDUCTIVE FEATURES FOR PREVENTING THE COUNTERFEITING OF A PRODUCT AND A METHOD FOR MANUFACTURING SUCH

(71) Applicant: WALKI GROUP, Valkeakoski (FI)

(72) Inventors: Tommi FORSLUND, Pietarsaari (FI); Tom MARTTILA, Espoo (FI)

(21) Appl. No.: 14/948,473

(22) PCT Filed: Jun. 3, 2013
(86) PCT No.: PCT/FI2013/050600

§ 371 Date: Nov. 23, 2015

(51) Int. Cl. G06K 19/077

(52) U.S. Cl. CPC G06K 19/07773; G06K 19/07758

(57) ABSTRACT

A sealing tag with conductive features, containing at least one conductive marking, pattern or surface, wherein each conductive marking, pattern, or surface and a substrate material are interconnected by an adhesive pattern or other bond. The sealing tag is characterized in that the size and shape of the adhesive pattern or other bond matches the main outlines of the conducting circuit pattern such that inside the area limited by the main outlines there is at least one area where the adhesion is strong and at least one area where the adhesion is weak. Additionally, a method for manufacturing such sealing tag is disclosed.

### CROSS-REFERENCE TO RELATED APPLICATIONS

The present application is a continuation of PCT Application No. PCT/FI2013/050600 filed Jun. 3, 2013, the entire disclosure of which is incorporated herein by reference.

### FIELD OF THE INVENTION

The invention relates to the sealing of products and to laminates with conductive parts, such as RFID antennas or tags, especially anti-counterfeiting RFID antennas.

### BACKGROUND INFORMATION

There are many ways previously known for producing the seals or signets for products. By sealing the package or housing of the product, it can be ensured, that the content will remain unchanged. The ancient seals were made of wax, clay or paper and it was used for authentication of a document or product.

Lately, also some implementations with RFID features have been developed. However, the known RFID implementations require special materials, which are more expensive and typically very difficult to utilize. The substrate material is typically designed to be weak and fragile. As a fragile tag or antenna is printed on a fragile substrate material, laminate, paper or plastic, the removal of the tag will break it. The processing of such fragile materials or products is very challenging especially for mass production, especially for reel-to-reel mass production.

Seals or signets with RFID features such as RFID antennas or RFID tags, which would be manufactured of normal materials easy to furnish and process, were not previously known. There are no products made of such typical materials, which are impossible or at least very difficult to remove such that the removal would not be detected visually and/or with an RFID reader. This kind of tag, label or antenna would be used as a seal confirming the authenticity of the product or document. As the tag, label or antenna is undamaged and it works correctly, the product or document could most probably be considered as authentic and genuine. This kind of so called “sealing tag” could be fastened on the product or document to confirm the authenticity of the product and prevent counterfeiting.

In this context, the term “sealing tag” may mean any one of the following:
anything that can be used as a seal, commonly called as a seal;
a member showing if tampering has been done, e.g. called as a tamper proof element;
RFID label or antenna with tamper proof properties, which may be called as a tamper proof label, tag or antenna;
a product with authentication possibilities, called as an anti-counterfeit element;
a tag with sealing properties;
a seal with a tag.

A typical example of the usage would be a bottle with some expensive beverage in it. The seal would attach to both the bottle and its cap such that the cap could not be removed without breaking the sealing tag. Further, some other typical items for sealing would be e.g. jewelry, cosmetics, electronics, CD, DVD blue ray discs etc.

### SUMMARY

The scope of the invention is to produce a sealing tag based on typical and usual materials, which are easy to furnish, supply, make and/or process, as mentioned above. Another scope of the invention is to produce a sealing tag on a stronger substrate material which will not break when used as the web in reel-to-reel production. Still another scope of the invention is to produce a conductive marking, pattern or surface, which may also be called a circuit pattern, or especially an RFID antenna or tag which cannot be removed from the object without being sufficiently broken to signal tampering.

The problems of the prior art are solved by a sealing tag of claim 1 as well as a method of claim 10. The solution according to the invention is characterized by what is included in the characterizing part of the corresponding claims.

The solution of the invention utilizes typical materials, and therefore, the delivery, production and handling does not require any special operations or process steps. The production of the antenna or tag of the invention is therefore as easy as of any other antenna or tag. The basic idea of the invention is to control the adhesion between the sealed product and the antenna, as well as the adhesion between the substrate material and the antenna. Being attached to the product with its antenna side toward the product, the antenna is partly tighter attached to the product and in the other parts tighter attached to the substrate material. With stronger adhesion to the product, the part of the antenna will stick onto the product, when the tag is removed. With stronger adhesion to the substrate material, the part of the antenna will remain on the substrate material. When the sealing tag is removed from the product, the parts of the antenna with stronger adhesion to the product will remain on the product, whereas the parts of the antenna with stronger adhesion to the substrate material will come off with the substrate material.

With sufficient adhesions on the materials, the removal of the tag will cause the antenna to partly stick on the sealed product and partly on the substrate material. This happens in a controlled manner: the antenna will break along the edges of the adhesion areas between the antenna and the substrate material. The breaking of the antenna can be further ensured and the breaking locations controlled by weakening the antenna at the desired breaking locations. The weakening can be done by making the antenna or conductive pattern thinner, narrower or perforated, and the weakenings can be placed anywhere where the adhesion to the substrate material is weaker than the adhesion to the product.

The invention is suitable for all circuit board manufacturing methods that allow the control of the strength of the bond between the conductive pattern and the substrate material so that at least two different bonding strengths can be achieved and selected for different parts of the conductive pattern. The scope of the invention includes using e.g. a metal foil or a laminate containing at least a conductive layer and a reinforcing layer for making the conductive pattern. Suitable known circuit board manufacturing methods are based on shaping the conductive pattern by die-cutting or lasering. Especially when the manufacturing process utilizes a laser, the weakening of the conductive pattern at the desired breaking points is relatively easy.

### BRIEF DESCRIPTION OF THE DRAWINGS

The invention will be described in more detail with the accompanying drawings.

FIG. 1 a cross-sectional view of an RFID tag of the invention attached on the sealed product

FIG. 2 a cross-sectional view of the RFID tag of the invention removed from the product

FIG. 3 a cross-sectional view of the RFID tag of the invention according to one preferred embodiment with partly covering an upper adhesive layer

FIG. 4 a cross-sectional view of the RFID tag of the invention with a weakened area on the metal foil

### DETAILED DESCRIPTION

In all figures, the reference numerals are designated as follows:

1 substrate material

2 patterned adhesive or other bonding

2a patterned adhesive area with higher adhesion

2b patterned adhesive area with lower adhesion

3 metal foil

3a piece of metal foil on the adhesive

3b piece of metal foil attached on the marked product

4 adhesive layer or glue line

4a adhesive layer area with lower adhesion

4b adhesive layer area with higher adhesion

5 marked product

6 a thinner area of the metal foil according to one embodiment of the invention

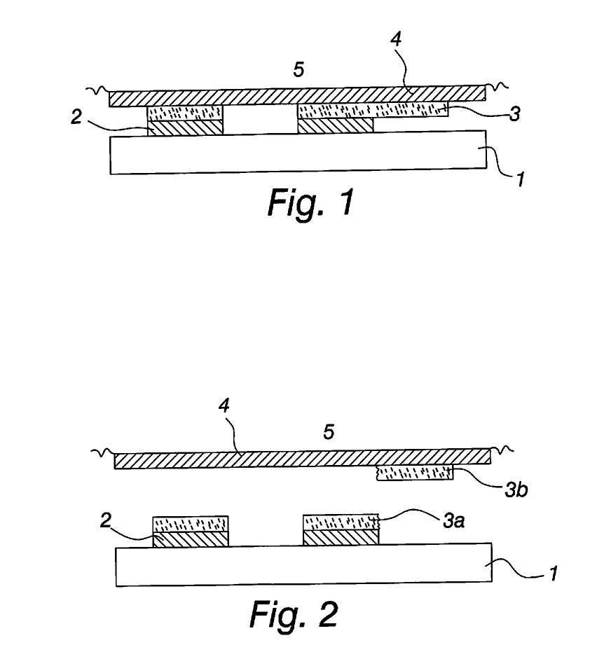

FIG. 1 shows the RFID tag of the invention attached on a product 5 that needs to be sealed or marked.

One preferred way to produce or manufacture the seal or sealing tag of the invention is to produce the conductive marking, pattern or surface 3 constituting the conductive parts or layers such as RFID antennas or tags of a conductive material, such as metal foil 3, formulating a circuit pattern. The metal foil 3 is attached tightly with the substrate material 1, which may be called a laminate, carrier material or substrate material, depending on the context. The attachment 2 is produced by adding an adhesive or some other bonding material 2 between the substrate 1 and metal foil 3. The adhesive 2 covers only a part of the metal foil area.

It is another preferred embodiment of the invention to use a plastic substrate material and to warm or heat up the substrate material such that it sticks onto the metal foil, antenna or other conductive material or pattern.

One preferred embodiment of the invention is to use a sufficiently strong adhesive for bonding the material used for the conductive patterns to the substrate material and to apply the adhesive in patterns that leave parts of the ready conductive patterns unattached to the substrate material. This allows the creation of two significantly different adhesion levels, one level created by the presence of the adhesive and the other level by the absence of the adhesive between the conductive pattern and the substrate material.

In another embodiment the substrate material is plastic and the bond is formed by selectively heating the substrate material while it is sufficiently tight against the material used for the conductive patterns, and selecting the heated areas so that parts of the ready conductive patterns are left unattached or weakly attached to the substrate material.

For manufacturing the seal or sealing tag of the invention the method presented in PCT application PCT/FI2009/050226 may preferably be used. Instead of creating a bond under the whole desired conductive pattern, some parts of the desired conductive pattern are left without the patterned adhesive or other bonding 2.

According to the invention, the seal with conductive features may contain at least one conductive marking, pattern or surface 3. Each conductive marking, pattern, or surface 3 and a substrate material 1 are interconnected by an adhesive pattern 2 or other bond. The conductive marking, pattern or surface 3 may have its internal precise pattern layouts, such as thin lines and thin interline spaces, patterned on top of the adhesive pattern 2 or other bond by a removal of the conductive material, such that the thin interline spaces of the conducting circuit patterns formed by the at least one conductive marking, pattern or surface may have residue of the bond. Outside the conducting markings, patterns or surfaces 3 main outlines, the substrate material 1 may be substantially void of an adhesive 2 or other bond connecting the conducting circuit pattern 3 to the substrate material 1, with the exception of edge areas of the main outlines. The size and shape of the adhesive pattern 2 or other bond matches the main outlines of the conducting circuit pattern 3 such that not more than the area limited by the main outlines is filled and at least one specific area inside the limited area is not filled.

In one preferred embodiment of the invention the conductive circuit patterns 3 are RFID antennas. In another preferred embodiment the said conductive circuit patterns are RFID tags.

The conductive pattern 3 may be e.g. a metal foil or any laminated structure. The pattern may be manufactured by any known method, which could be e.g. laser or die-cutting.

In one preferred embodiment the seal sticks on a product 5 by means of an adhesive layer 4, which may be e.g. a glue line or a homogenous and uniform layer of glue or other adhesive material. The adhesive layer may also be a pressure sensitive adhesive.

According to the present invention the method for manufacturing a sealing tag with conductive features, may include the steps of affixing, patterning and removing according to the prior art. Further a part of the conductive layer 3 is left unattached but not removed, leaving on the sealing tag a part 3b of the conductive marking, pattern or surface 3 that is not affixed by means of a bond 2.

In one preferred embodiment, on the top of at least the conductive patterns 3, and at least a part of the antenna or tag, is spread another adhesive layer 4 with adhesion sufficient to break the conductive marking, pattern or surface 3. In one embodiment this means less adhesion than adhesive layer 2. In general, the effect of the invention is achieved by the adhesive layer 4 with more adhesion than the internal strength of the conductive marking, pattern or surface. Below also some embodiments for creating the inventive effect by weakening the conductive layer instead of patterning the adhesive layer 2 only are described. The layer 4 may be produced as glue lines. The adhesive layer 4 sticks the sealing tag on the product 5 that needs to be sealed.

FIG. 2 shows the RFID tag ripped off the product 5. As the bonding material 2 is stronger than the glue layer 4, and the glue layer 4 has stronger adhesion than the unglued interspace between the substrate 1 and the conductive pattern 3, the conductive part 3b is more tightly attached to the product 5 then the part 3a to the substrate 1. This causes the RFID antenna 2 to break in a controlled manner depending on the location of the adhesive material 2. The remaining part of the antenna 2 could still be read by an RFID reader, but the breaking points can be located such that the remaining pattern 3a of the metal foil 3 has some RF features sufficiently differing from the original RF features of the antenna to detect that the antenna is broken.

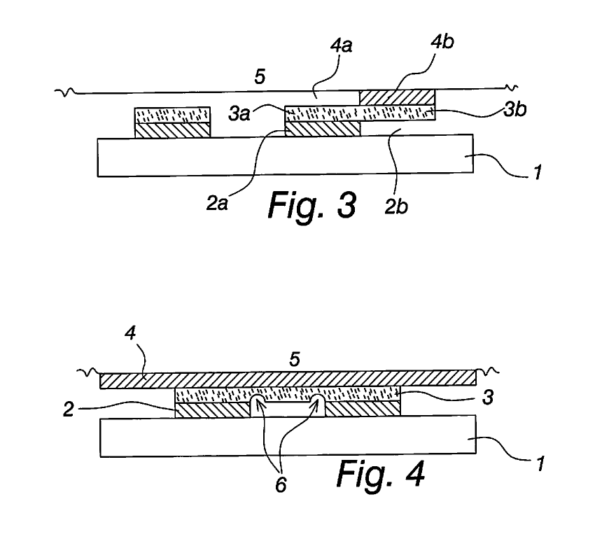

FIG. 3 shows an alternative way to utilize the invention. In general, according to FIGS. 1 and 2, the adhesion on layer 2 should be stronger than the adhesion on layer 4. The goal of this requirement is that substantially the parts 3b have stronger adhesion to the product 5 than to substrate 1, and the parts 3a have stronger adhesion to the substrate 1 than to the product 5. However, the adhesive layer 4 may also be patterned such that the adhesive material only covers the areas 3b, which should stick on the product 5. In that case, the adhesion of the bond 4 may be almost anything. The layers 4 and 2 are now heterogenous and the layer 2 on area 2a has higher adhesion than the layer 4 on area 4a, and the layer 4 on area 4b has higher adhesion than layer 2 on area 2b.

When utilizing heterogenous or irregularly spread adhesives on layers 2 and 4, the adhesive material does not have to be totally left off in the areas 2b and 4a. Instead, the adhesion on the area 2b can be arranged to be lower than on the area 2a, as well as the adhesion on the area 4a can be arranged to be lower than on the area 4b. This can be gained with many possible adhesions, which adhere better than a totally non adhesive surface.

As the adhesion levels as such may be almost anything, and the relation of the different adhesions is essential, terminology with the wording “adhesion is strong” or “being strongly affixed” as well as reversed corresponding “adhesion is weak” is used. This generally means the relative values of the adhesion. In some embodiments they may mean essentially the highest and lowest possible adhesions gained by some specific manufacturing process, but it is not necessary in all embodiments.

Further, when utilizing a metal foil 3 as conductive patterns and laser for the patterning method, the conductive pattern may be weakened on the desired breaking points. The weakening may be done by making the pattern thinner or narrower, as well as by perforating it.

FIG. 4 shows still one other possible way to utilize the invention. The weakening 6 of the conductive pattern 3 may be done in some other area of the pattern 3, which is not attached with the adhesive 2. In this embodiment any area inside the conductive pattern part 3b (see FIG. 2) is suitable.

Further, the seal of the invention may include several conductive and substrate layers.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A sealing tag with conductive features, containing at least one conductive marking, pattern or surface, wherein
each conductive marking, pattern, or surface (3) and a substrate material (1) are interconnected by an adhesive pattern (2) or other bond,
characterized in that
the size and shape of said adhesive pattern (2) or other bond matches the main outlines of the conducting circuit pattern (3) such that inside the area limited by the main outlines there is at least one area (2a) where the adhesion is strong and at least one area (2b) where the adhesion is weak.

2. The sealing tag of claim 1, characterized in that not more than the area limited by the main outlines is filled and at least one specific area inside the limited area is not filled with the adhesive.

3. The sealing tag of claim 1 or 2, characterized in that the conductive marking, pattern or surface (3) has its internal precise pattern layouts, such as thin lines and thin interline spaces, patterned on top of the adhesive pattern (2) or other bond by a removal of the conductive material, such that the thin interline spaces of the conducting circuit patterns formed by the at least one conductive marking, pattern or surface may have residues of the bond.

4. The sealing tag of any one of claims 1-3, characterized in that outside the conducting markings, patterns or surfaces (3) main outlines, the substrate material (1) is substantially void of an adhesive (2) or other bond connecting the conducting circuit pattern (3) to the substrate material (1), with the exception of edge areas of the main outlines.

5. The sealing tag of any one of claims 1-4, characterized in that the said conductive circuit patterns are RFID antennas.

6. The sealing tag of any one of claims 1-5, characterized in that the said conductive circuit patterns are RFID tags.

7. The sealing tag of any one of claims 1-6, characterized in that the seal sticks on a product (5) by means of an adhesive layer (4).

8. The sealing tag of any one of claims 1-7, characterized in that in the conductive circuit pattern (3) outside the area of the bond (2) there are areas (6) wherein the pattern (3) is weakened to cause the breaking on that exact point as the seal is ripped off.

9. The sealing tag of any one of claims 1-8, wherein the sealing tag is a seal; a tamper proof element, label, tag or antenna; anti-counterfeit element; a tag with sealing properties; or a seal with a tag.

10. A method for manufacturing a sealing tag with conductive features, including the following steps of:
i) affixing a conductive layer (3) to a substrate material (1) by means of a bond (2) and leaving the removal-intended more extensive areas unattached to the substrate material (1); and
ii) removing the removable areas from the conductive layer;
characterized in that
further a part of the conductive layer (3) is left with less adhesion in step i) but not removed in step ii) leaving on the sealing tag a part (3b) of the conductive marking, pattern or surface (3) that is not strongly affixed by means of a bond (2).

11. The method of claim 10, characterized in that the part of the conductive layer (3) is left unattached in step i) but not removed in step ii) leaving on the sealing tag a part (3b) of the conductive marking, pattern or surface (3) that is not affixed by means of a bond (2).

12. The method of claim 10 or 11, characterized in that the conductive marking, pattern or surface (3) is weakened to cause the breaking on that exact point as the seal is ripped off.

13. The method of any one of claims 10-12, characterized in that on the top of the conductive marking, pattern or surface (3), the bond (2) and the substrate material (1) is spread another adhesive layer (4) with adhesion sufficient to break the conductive marking, pattern or surface (3).

14. The method of any one of claims 10-13, characterized in that the said another adhesive layer (4) sticks the sealing tag on a product (5).
